(19) United States
(12) Patent Application Publication
(10) Pub. No.: US 2020/0379471 A1
(43) Pub. Date: Dec. 3, 2020

(54) TRAFFIC BLOCKING DETECTION

(71) Applicant: Byton North America Corporation, Santa Clara, CA (US)

(72) Inventors: Dirk Abendroth, Mountain View, CA (US); Baharak Soltanian, Mountain View, CA (US)

(21) Appl. No.: 16/429,231

(22) Filed: Jun. 3, 2019

(51) Int. Cl. G05D 1/02; G06K 9/00; G06N 3/08

(52) U.S. Cl. CPC G05D 1/0221; G06K 9/00805; G05D 2201/0213; G06N 3/08; G06K 9/00818

(57) ABSTRACT

Vehicles, methods, machine readable media and processing systems are described in which assisted driving or autonomous driving use a first trained model to recognize moving objects, such as vehicles and pedestrians, and use a second trained model to recognize stationary road landmarks, such as road signs, and stationary road obstacles such as road barriers or abandoned car parts, etc. The trained models can be implemented through, in one embodiment, a single trained neural network or through, in another embodiment, two separate trained neural networks.

### BACKGROUND

This disclosure relates generally to vehicles that include sensors for assisted driving or autonomous driving.

Presently, there is considerable research and development directed to vehicles, such as cars, sport utility vehicles (SUVs), trucks and other motorized vehicles, that include sensors that are configured to obtain data about moving objects surrounding a vehicle. These sensors often include cameras that acquire optical images, ultrasonic sensors that use ultrasound, radar sensors that use radar techniques and technology, and LIDAR sensors that use pulsed infrared lasers. Data from these sensors can be processed both individually and collectively to attempt to recognize (e. g., classify) moving objects surrounding a vehicle that includes the sensors. For example, the data from a camera and a radar or a LIDAR system can be processed to recognize other vehicles and pedestrians that move in the environment around the vehicle. A processing system can then use the information about the recognized moving vehicles and pedestrians to provide assisted driving or autonomous driving of the vehicle. For example, while the vehicle is driving with assisted cruise control, the processing system can use information about a recognized vehicle that is in front of the vehicle to provide adequate space in front of the vehicle when the recognized vehicle slows down; normally, assisted cruise control will cause the vehicle to slow down in this situation in order to maintain the adequate space in front of the vehicle.

### SUMMARY OF THE DESCRIPTION

The embodiments of this disclosure relate to vehicles, processing systems, methods, and non-transitory machine readable media in which assisted driving or autonomous driving can use a first trained model to recognize moving objects and also use a second trained model to recognize stationary road landmarks, such as road signs, and stationary road obstacles, such as road bear barriers, etc.

For one embodiment, a method can include the following operations: receiving a first set of data from a set of sensors on a vehicle, the set of sensors configured to obtain data about objects surrounding the vehicle; processing the first set of data using a first trained model to recognize one or more moving objects represented in the first set of data, the first trained model having been trained to recognize moving objects on or near roads; and processing the first set of data using a second trained model to recognize one or more stationary road landmarks or stationary road obstacles represented in the first set of data, the second trained model having been trained to recognize stationary road landmarks or stationary road obstacles on or near roads. For one embodiment, the method can also include providing at least one of assisted driving of the vehicle or autonomous driving of the vehicle based on the recognition of the one or more moving objects and the recognition of the one or more stationary road landmarks or stationary road obstacles. For one embodiment, the assisted driving can include one or more of: automatic lane departure prevention, automatic collision avoidance, automatic stopping, automatic cruise control, etc. For one embodiment, the first trained model and the second trained model can be embodied in a single neural network that includes both of the first trained model and the second trained model; for an alternative embodiment, the first trained model can be embodied in a first neural network, and the second trained model can be embodied in a second neural network that are separate. In addition, conventional computer vision may be used to recognize stationary objects.

For one embodiment, the method can further include: updating data for a first map stored locally and persistently in nonvolatile memory in the vehicle to include a representation of a recognized stationary road landmarks or stationary road obstacle in the first map; this updating can store the representation of the recognized stationary road landmark or recognized stationary road obstacle for future assisted driving or autonomous driving by one or more processing systems which can take into account the stationary objects when performing assisted driving or autonomous driving after the first map has been updated. For one embodiment, the method can further include the operation of: transmitting, to a set of one or more server systems, data to include the representation of the recognized stationary road landmark or stationary road obstacle in a second map maintained by one or more server systems, wherein the second map can be distributed to the other vehicles through transmissions from the one or more server systems.

For one embodiment, the method can further include the operation of: updating the data for the first map to remove the representation of the recognized stationary road landmark or stationary road obstacle in response to the one or more data processing systems determining that the stationary road landmark or stationary road obstacle has been removed from the road.

For one embodiment, at least a subset of the stationary road landmarks or stationary road obstacles have known static sizes and known static shapes and known color patterns which are used when training the second trained model to recognize stationary road obstacles or road landmarks. For one embodiment, the one or more moving objects can include vehicles, bicycles, motorcycles and pedestrians, and the one or more stationary landmarks or stationary road obstacles can include one or more of: road signs, road barriers or blockades; abandoned car parts, pylons or traffic cones, debris on a road, rocks, or logs. For one embodiment, the set of sensors can include a combination of: one or more LIDAR sensors; one or more radar sensors; and one or more camera sensors which provide the first set of data to computer vision algorithms that recognize the stationary road landmarks or stationary road obstacles.

A vehicle for one embodiment can include the following: a set of one or more sensors configured to obtain data about objects surrounding the vehicle; a steering system coupled to at least one wheel in a set of wheels; one or more motors coupled to at least one wheel in the set of wheels; a braking system coupled to at least one wheel in the set of wheels; a memory storing a first trained model and a second trained model; and a set of one or more processing systems coupled to the memory and to the set of one or more sensors and to the steering system and to the braking system and to the one or more motors; the set of one or more processing systems can be configured to receive a first set of data from the set of one or more sensors and to process the first set of data using the first trained model to recognize one or more moving objects represented in the first set of data, wherein the first trained model has been trained to recognize moving objects on or near roads; and the set of one or more processing systems is further to process the first set of data using the second trained model to recognize one or more stationary road landmarks or stationary road obstacles represented in the first set of data, wherein the second trained model has been trained to recognize stationary road landmarks or stationary road obstacles on or near roads.

For one embodiment, the vehicle can include one or more processing systems that provide at least one of assisted driving of the vehicle or autonomous driving of the vehicle based upon the recognition of the one or more moving objects and the recognition of the one or more stationary road landmarks or stationary road obstacles. For one embodiment, the assisted driving can include one or more of: automatic lane departure prevention; automatic collision avoidance; assisted parking; vehicle summon; automatic collision avoidance; and automatic stopping. For one embodiment, a vehicle can include a first map which is stored locally and persistently in the memory of the vehicle, and the set of one or more processing systems can update data for the first map to include a representation of a recently recognized stationary road landmark or a recently recognized stationary road obstacle in the first map, and the set of one or more processing systems in the vehicle can use the updated map for use in future assisted driving or autonomous driving to avoid the obstacles based upon their stored location in the first map. For one embodiment, the set of one or more processing systems can cause a transmission, to a set of one or more server systems, of the updated data to include the representation of the recognized stationary road landmark or stationary road obstacle in a second map maintained by a set of one or more server systems, wherein the second map is configured to be distributed to other vehicles through transmissions from the set of one or more server systems. For one embodiment, the first map can be modified to remove the representation in response to the set of one or more processing systems determining, from data from the set of sensors that the stationary road landmark or stationary road obstacle has been removed from a location specified in data associated with the representation, and wherein the representation can include an icon displayed on the first map. For one embodiment, the vehicle can include a single neural network that includes both of the first trained model and the second trained model, while in an alternative embodiment, the first trained model can be embodied in a first neural network and the second trained model can be embodied in a second neural network which is separate and distinct from the first neural network.

The embodiments described herein can include methods and vehicles which use the methods described herein. Moreover, the embodiments described herein can include non-transitory machine readable media that store executable computer program instructions that can cause one or more data processing systems to perform the one or more methods described herein when the computer program instructions are executed by the one or more data processing systems. The instructions can be stored in nonvolatile memory such as flash memory or dynamic random access memory or other forms of memory.

The above summary does not include an exhaustive list of all embodiments in this disclosure. All systems and methods can be practiced from all suitable combinations of the various aspects and embodiments summarized above and also those disclosed in the Detailed Description below.

The above summary does not include an exhaustive list of all embodiments in this disclosure. All systems and methods can be practiced from all suitable combinations of the various aspects and embodiments summarized above, and also those disclosed in the Detailed Description below.

### BRIEF DESCRIPTION OF THE DRAWINGS

The present embodiments are illustrated by way of example and not limitation in the figures of the accompanying drawings in which like references indicate similar elements.

FIG. 1 shows an example of a training system which can be used in one or more embodiments described herein.

FIG. 2 is a flowchart which illustrates a method, according to one or more embodiments described herein, in a training system in order to obtain trained models that can be used by a vehicle while the vehicle is operating on roads.

FIG. 3 shows a diagram which indicates how data from different sensors can be combined using conventional sensor fusion processing and then used with the trained models described herein to provide outputs which can be used for assisted driving and/or autonomous driving.

FIG. 4 is a flowchart which illustrates a method according to one embodiment for using the trained models while a vehicle is being driven along one or more roads.

FIG. 5 is a flowchart which illustrates a method according to one embodiment in which map information can be updated by removing a stationary object which had been previously added to a local map on the vehicle.

FIG. 6 shows an example of a vehicle which includes one or more processing systems according to one or more embodiments described herein.

### DETAILED DESCRIPTION

Various embodiments and aspects will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments.

Reference in the specification to “one embodiment” or “an embodiment” means that a particular feature, structure, or characteristic described in conjunction with the embodiment can be included in at least one embodiment. The appearances of the phrase “in one embodiment” in various places in the specification do not necessarily all refer to the same embodiment. The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

The embodiments described herein can utilize two trained models which have been trained to recognize two different types of objects that can be encountered by a vehicle while the vehicle is operating on the roads. The two trained models can be implemented in two separate neural networks or in one neural network that has been trained to include both trained models. For one embodiment, a first trained model is trained to recognize moving objects such as vehicles, pedestrians, bicycles, motorcycles, and other moving objects on or near roads. The other trained model is trained to recognize stationary road landmarks or stationary road obstacles or both based upon known shapes, sizes, and color patterns of those landmarks and obstacles. The vehicle can use both models together to provide assisted driving and/or autonomous driving which can benefit by being able to recognize not only moving objects but also stationary road landmarks and stationary road obstacles. For example, when the system has recognized a stationary road landmark such as a construction sign or a road sign which indicates that the vehicle needs to move over by one lane to the left, the assisted driving system or the autonomous driving system can recognize the road landmark and cause the vehicle to move one lane to the left in order to avoid the road landmark. Alternatively, the vehicle can alert the driver of the presence of the road landmark to request the driver to move to the left.

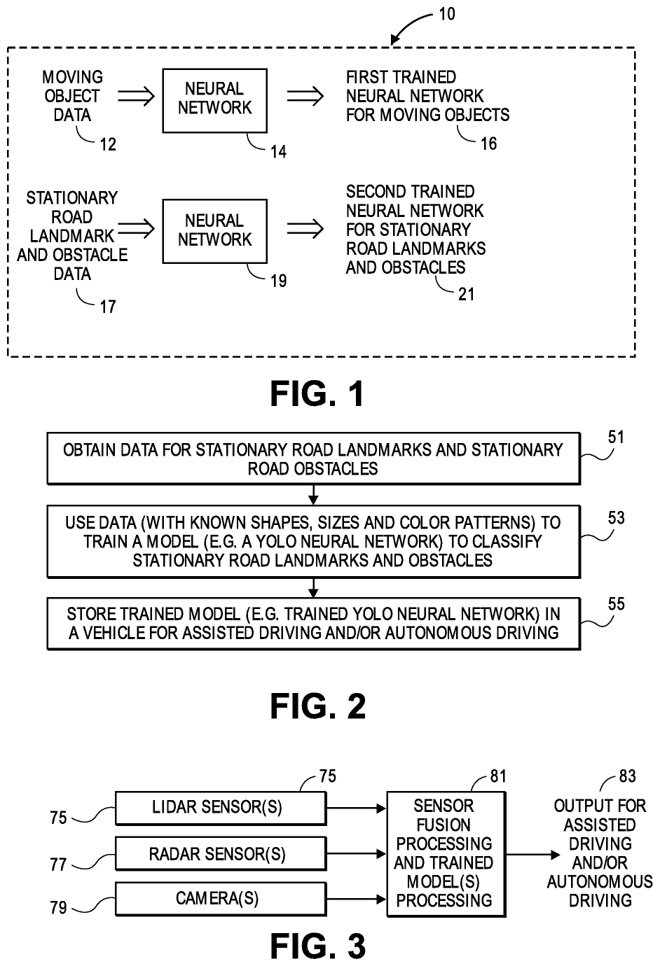

FIG. 1 shows an example of the training system 10 which can be used to train one or more neural networks to provide the two trained models which can be used as described herein. The first trained model can be used to recognize moving objects, such as other vehicles and pedestrians, and the second trained model can be used to recognize and classify stationary road landmarks such as road construction signs or road signs on or near the road as well as to recognize stationary road obstacles such as pylons, traffic cones, road debris such as abandoned car parts (e.g. tires), barricades, blockades, and road barriers. The information about such landmarks and obstacles can include standard or known sizes, shapes and color patterns of such objects worldwide or within selected regions of the world. If the vehicle is intended for distribution and use within a selected region (and not others), the trained models can be limited to landmarks and obstacles in just those selected regions where the vehicle will operate.

The training system 10 can be trained by obtaining two different types of data. The first type of data is data for moving objects, such as a moving object data 12. In one embodiment, moving object data 12 can be data obtained by driving vehicles around which observe other vehicles and pedestrians while the vehicle is being driven around. The moving object data 12 can be used to train a neural network 14 which in turn, when trained, can produce first trained neural network 16 for moving objects. The first trained neural network 16 can be used to recognize moving objects. In one embodiment, the YOLO model for a neural network can be used to create the trained neural network 16 using conventional techniques known in the art for creating a YOLO neural network that can recognize moving objects. For one embodiment, stationary road landmark data and stationary road obstacle data 17 can be obtained and used as an input to train a neural network 19 which in turn can produce a trained neural network 21 which can be referred to as the second trained neural network which can be used for the recognition and classification of stationary road landmarks and stationary road obstacles. For one embodiment, the first trained neural network 16 and the second trained neural network 21 can be stored in memory in a vehicle for use while the vehicle is driving to provide assisted driving and/or autonomous driving. For an embodiment in which a single trained neural network contains both trained models, a single neural network (e.g. neural network 14) can be trained using both data 12 and data 17 to create the single trained neural network.

FIG. 2 represents a method which can be used with the training system 10 shown in FIG. 1. In operation 51 of FIG. 2, data for stationary road landmarks and stationary road obstacles is obtained; the data 17 shown in FIG. 1 is an example of such data which is obtained in operation 51. Then in operation 53, the data, such as data 17, is used to train a model, such as a model of a neural network using the YOLO model. This produces a trained neural network which is designed to recognize and classify stationary road landmarks and stationary road obstacles. This trained model can then be stored in a vehicle for use when the vehicle is driving or otherwise operating on roads. For example, these models can be used for assisted driving and/or autonomous driving.

FIG. 3 shows an example of how data from a variety of sensor systems can be used along with sensor fusion processing and the trained models to provide an output for assisted driving and/or autonomous driving. In the example shown in FIG. 3, the set of sensors includes one or more LIDAR sensors 75, one or more radar sensors 77, and one or more cameras 79. The LIDAR sensors 75 can use pulsed infrared laser sensors, the radar sensors 77 can use radiofrequency radar technology to sense objects, and the cameras 79 can be conventional optical cameras which capture optical images. The output from these sensors can be provided to conventional sensor fusion processing 81 which can fuse the results of the output from the sensors into data that can be then processed using the trained models described herein. These trained models can in turn provide an output 83 which can be used to provide assisted driving and/or autonomous driving. The assisted driving can include one or more of automatic lane departure prevention, automatic collision avoidance, automatic stopping, vehicle summon, and other known assisted driving operations. The autonomous driving which can be provided as a result of the output 83 can provide for a vehicle which can drive itself and not require the passengers to control the vehicle while the vehicle drives by itself autonomously. The assisted driving or autonomous driving can change lanes based on the detected road obstacles.

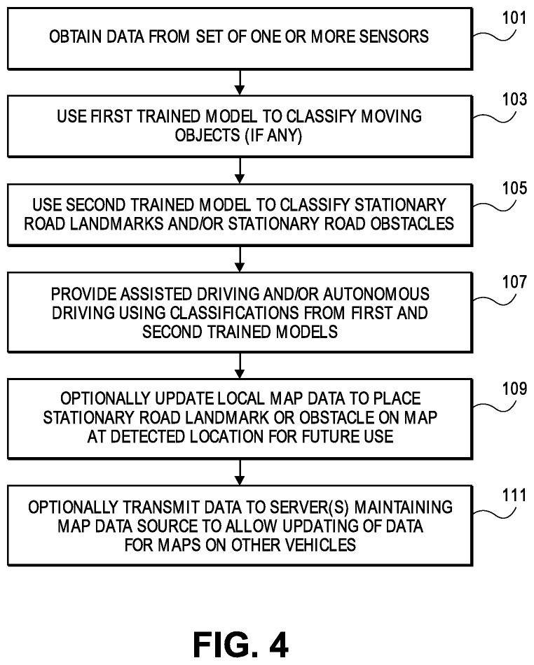

A vehicle can operate using the method shown in FIG. 4 after it has stored the trained models described herein which can recognize both moving objects and stationary road landmarks and stationary road obstacles. In operation 101, data from a set of one or more sensors, such as LIDAR sensor(s) 75, radar sensor(s) 77, and camera(s) 79 can be obtained from the sensors on the vehicle. The data from these sensors can be fused as is known in the art and then provided to a first trained model in operation 103 to classify moving objects and then provided to a second trained model to classify stationary objects such as stationary road landmarks and/or stationary road obstacles in operation 105. It will be appreciated that the sequence of the operations 103 and 105 can be reversed or can occur concurrently at the same time in a single trained neural network.

For one embodiment, the first trained model can be implemented in the same neural network as the second trained model; in an alternative embodiment, the first trained model can be implemented in a first neural network which is separate and distinct from a second neural network which implements the second trained model. The stationary road landmarks and the stationary road obstacles can include all of the objects which were used during the training, such as the training implemented by training system 10; for example all of the stationary road landmarks and obstacle data 17 which were used to train neural network 19 can be recognized by the second trained model in operation 105. In operation 107, one or more data processing systems in the vehicle can use the recognized objects (including recognized moving objects and recognized stationary objects) to provide assisted driving and/or autonomous driving using the classifications from the first and the second trained models. For example, if the sensors have detected a moving vehicle in front of the vehicle and also detected a road sign indicating that the vehicle is to move to the left lane (from the right lane where the vehicle is currently traveling), the assisted driving and/or autonomous driving system in the vehicle can cause the vehicle to move to the left lane while assuring that it maintains an adequate safe distance behind the vehicle in front of it and while also allowing the vehicle in front of it to also move into the left lane from the right lane.

The method shown in FIG. 4 also includes two optional operations, operations 109 and 111, which can be used in conjunction with one or more maps (or other data structures) used with the vehicle. In particular, in operation 109, a local map which is stored locally in the vehicle, in persistent memory in the vehicle, can be optionally updated to place a representation of the recognized stationary road landmarks or recognized road obstacle on the map at the detected location on the map and this updated map can be displayed to the driver/passenger. This updating of the map data can be used in future use of the assisted driving and/or autonomous driving when the vehicle passes in the vicinity of the previously recognized stationary object again. For example, if the vehicle traveled on Monday around a road obstacle and added the obstacle to the map on the vehicle on Monday, the vehicle can use the representation of the stationary object placed on the map for future assisted driving (e.g., on the Tuesday that follows the Monday) when the vehicle is in the vicinity of the obstacle in future circumstances. During those future circumstances (subsequent to the addition of the representation of the landmark or obstacle to a map or other data structure), the assisted driving or autonomous driving system can anticipate, at a point in the journey before reaching the previously recognized landmark or obstacle, that action should be taken (e.g. move the vehicle to the left lane in the road before encountering the landmark or obstacle) and take the action well before reaching the previously recognized landmark or obstacle. In this example, the assisted driving system or autonomous driving system can look ahead along the expected or known path of the vehicle to anticipate a desired action based on the previously recognized stationary object that has been added to the vehicle's local map (or other data structure). In addition to the storage of the information about the stationary object on a local map, the vehicle can also optionally transmit data, in operation 111, to one or more servers that maintain a second map to allow updating of data of the second map which can then be used to transmit that representation of the discovered obstacle to other vehicles so that their maps can be updated for assisted driving and/or autonomous driving using the updated maps on those other vehicles.

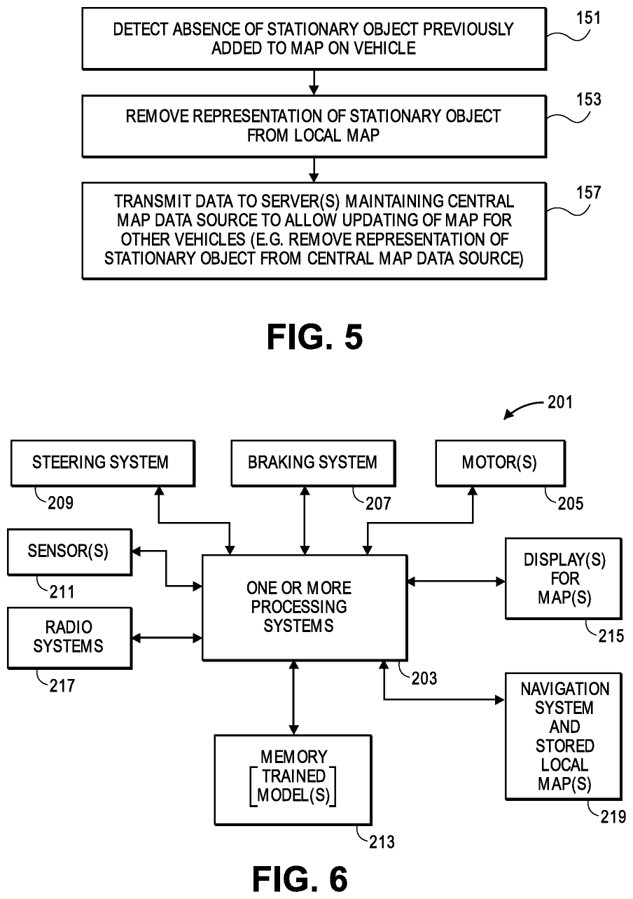

Stationary objects such as road obstacles can often be temporary objects that exist while a road project or construction project is being performed and are then removed from the location of the project when the project is completed. Thus, while a stationary object can be added to the map at one point in time in an embodiment, another embodiment described herein allows the representation of the previously added obstacle or landmark to be removed from both the local map maintained in the vehicle and a remote or second map maintained by one or more remote servers. An example of a method which removes such previously recognized stationary objects is shown in FIG. 5. The method of FIG. 5 can begin in operation 151 in which the absence of a previously detected stationary object is determined. For example, a vehicle can approach or pass by a location in which a stationary object had been previously located and the one or more processing systems can determine that the object has now been removed (e.g., the system determines that the object is absent at the stored location). The system in operation 151 can detect this absence which can cause operation 153 in which a representation of the stationary object is removed from a local map at the stored location maintained in the vehicle. In addition and as an optional operation, the vehicle can perform operation 157 in which it transmits data to one or more servers maintaining a central map data source to allow updating of that map for other vehicles to allow the other vehicles to remove the representation of the stationary object from their maps. This allows other vehicles to obtain updated data from the central map data source to remove the stationary object from their locally maintained maps.

FIG. 6 shows an example of the vehicle 201 which can be used to perform one or more embodiments described herein. The vehicle 201 can include a steering system 209 which is coupled to at least one wheel in a set of wheels on the vehicle. A braking system 207 can also be coupled to at least one wheel on the vehicle, and a set of one or more motors 205 can also be coupled to at least one wheel in the set of wheels on the vehicle 201. In one embodiment, the motors 205 can be electric motors that are powered by an electric battery which provides the majority or all of the power for the vehicle 201. The vehicle 201 also includes one or more processing systems 203 which are coupled to the steering system 209, the braking system 207, and the one or more motors 205. In addition, the one or more processing systems 203 are coupled to a set of one or more sensors 211 (such as the sensors shown in FIG. 3) and a set of one or more radio systems 217. Further, the one or more processing systems 203 are coupled to one or more displays 215 which can be configured to display maps, such as the local map updated in operation 109 in FIG. 4 herein. Moreover, the one or more processing systems 203 can be coupled to a navigation system 219 (e.g., GPS or GNSS system) which includes a stored local map, such as the stored local map described herein and which can be updated in operation 109 or updated in operation 153 as described herein. In addition, the one or more processing systems 203 can be coupled to persistent nonvolatile local memory (e.g., a non-transitory machine readable medium) in the vehicle 201 such as memory 213 which can be used to store executable computer programs which can cause the one or more processing systems to perform instructions to cause any one of the methods described herein to be performed. The memory 213 can also include the trained models such as the trained neural network 16 and the trained neural network 21 shown in FIG. 1. During operation of the vehicle, the one or more processing systems 203 can receive data from the set of one or more sensors 211 (e.g., LIDAR sensor(s) 75, radar sensor(s) 77, and camera(s) 79) and use the data to recognize or classify moving objects using the first trained model (e.g., as in operation 103 in FIG. 4) and using the second trained model to classify stationary objects (e.g., as in operation 105 shown in FIG. 4). Based on the classification of the objects from the first trained model and the second trained model, the one or more processing systems 203 can provide assisted driving or autonomous driving by controlling the steering system 209 and the braking system 207 and the one or more motors 205.

For example, the one or more processing systems can detect the presence of a road obstacle in the right lane which is blocking the lane the vehicle is currently driving in, and the one or more processing systems can determine that the vehicle needs to move to the left lane but there is another vehicle in the left lane that blocks the move. Thus the one or more processing systems cause the vehicle to slow down to allow the vehicle in the left lane to pass it to then allow the vehicle to be moved into the left lane after the vehicle in the left lane has cleared the left lane to allow the vehicle to move into the left lane and continue past the road obstacle which blocks the current path of travel of the vehicle. The one or more processing systems can also cause the updating of the local map (or other data structure) in the navigation system 219 to cause a representation of the detected or recognized road obstacle to appear on the map in the display 215. Moreover, the one or more processing systems 203 can cause one or more radio systems 217 to transmit data to one or more servers maintaining a second or central map data source to allow the updating of the map for other vehicles. These one or more servers can then transmit updated map information to those other vehicles which can be similar to the vehicle shown in FIG. 6.

In the foregoing specification, specific exemplary embodiments have been described. It will be evident that various modifications may be made to those embodiments without departing from the broader spirit and scope set forth in the following claims. The specification and drawings are, accordingly, to be regarded in an illustrative sense rather than a restrictive sense.

What is claimed is:

1. A non-transitory machine readable medium storing executable program instructions which when executed by one or more processing systems cause the one or more processing systems to perform a method comprising:
receiving a first set of data from a set of sensors on a vehicle, the set of sensors configured to obtain data about objects surrounding the vehicle;
processing the first set of data using a first trained model to recognize one or more moving objects represented in the first set of data, the first trained model having been trained to recognize moving objects on or near roads; and
processing the first set of data using a second trained model to recognize one or more stationary road obstacles represented in the first set of data, the second trained model having been trained to recognize stationary road obstacles on or near roads.

2. The medium as in claim 1 wherein the method further comprises:
providing at least one of assisted driving of the vehicle or autonomous driving of the vehicle based on the recognition of the one or more moving objects and the recognition of the one or more stationary road obstacles; wherein assisted driving comprises one or more of: automatic lane changes; automatic collision avoidance; and automatic stopping.

3. The medium as in claim 2 wherein the method further comprises:
updating data for a first map stored locally and persistently in memory in the vehicle to include a representation of a recognized stationary road obstacle in the first map; and
wherein the updating stores the representation of the recognized stationary road obstacle for future assisted driving or autonomous driving by the one or more processing systems which can take the stationary objects into account for assisted driving or autonomous driving.

4. The medium as in claim 3 wherein the method further comprises:
transmitting, to a set of one or more server systems, data to include the representation of the recognized stationary road obstacle in a second map maintained by the one or more server systems, the second map to be distributed to other vehicles through transmissions from the one or more server systems.

5. The medium as in claim 3 wherein the method further comprises:
updating the data for the first map to remove the representation of the recognized stationary road obstacle in response to the one or more data processing systems determining the stationary road obstacle has been removed from the road.

6. The medium as in claim 3 wherein at least a subset of the one or more stationary road obstacles have known static sizes and known static shapes and known color patterns which are used when training the second trained model.

7. The medium as in claim 6 wherein the one or more moving objects comprise vehicles, bikes and pedestrians and wherein the one or more stationary road obstacles include one or more of: (a) road signs on road; (b) road barriers or blockages; (c) abandoned car parts; (d) pylons or traffic cones; (e) debris on road; (f) rocks or (g) logs.

8. The medium as in claim 7 wherein the set of sensors comprise a combination of: (a) one or more LIDAR sensors; (b) one or more radar sensors; and (c) one or more camera sensors; and the set of sensors provide the first set of data to computer vision algorithms that recognize the stationary road obstacles.

9. The medium as in claim 8 wherein the first trained model and the second trained model are embodied in a single neural network that includes both of the first and the second trained model.

10. The medium as in claim 8 wherein the first trained model is embodied in a first neural network and the second trained model is embodied in a second neural network.

11. A vehicle comprising:
a set of one or more sensors configured to obtain data about objects surrounding the vehicle;
a steering system coupled to at least one wheel in a set of wheels;
one or more motors coupled to at least one wheel in the set of wheels;
a braking system coupled to at least one wheel in the set of wheels;
a memory storing a first trained model and a second trained model;
a set of one or more processing systems coupled to the memory and to the set of one or more sensors and to the steering system and to the braking system and to the one or more motors, the set of one or more processing systems to receive a first set of data from the set of one or more sensors, the set of one or more processing systems to process the first set of data using the first trained model to recognize one or more moving objects represented in the first set of data, the first trained model having been trained to recognize moving objects on or near roads, and the set of one or more processing systems to process the first set of data using the second trained model to recognize one or more stationary road obstacles represented in the first set of data, the second trained model having been trained to recognize stationary road obstacles on or near roads.

12. The vehicle as in claim 11 wherein the set of one or more processing systems provide at least one of assisted driving of the vehicle or autonomous driving of the vehicle based on the recognition of the one or more moving objects and the recognition of the one or more stationary road obstacles; and wherein assisted driving comprises one or more of: automatic lane changes; automatic collision avoidance; and automatic stopping.

13. The vehicle as in claim 12 wherein the set of one or more processing systems update data for a first map stored locally and persistently in memory in the vehicle, to include a representation of a recognized stationary road obstacle in the first map, and wherein the updated data stores the representation for use in future assisted driving or autonomous driving by the set of one or more processing systems.

14. The vehicle as in claim 13 wherein the set of one or more processing systems cause a transmission, to a set of one or more server systems, of data to include the representation of the recognized stationary road obstacle in a second map maintained by the set of one or more server systems, the second map configured to be distributed to other vehicles through transmissions from the set of one or more server systems.

15. The vehicle as in claim 13 of the first map is modified to remove the representation in response to the set of one or more processing systems determining, from data from the set of sensors, that the stationary road obstacle has been removed from a location specified in data associated with the representation and wherein the representation comprises an icon displayed on the first map.

16. The vehicle as in claim 13 wherein at least a subset of the one or more stationary road obstacles have known static sizes and known static shapes and known color patterns that are used to train the second trained model to recognize stationary road obstacles.

17. The vehicle as in claim 16 wherein the one or more moving objects comprise vehicles, motorcycles, bicycles and pedestrians and wherein the one or more stationary road obstacles include one or more of: (a) road signs blocking the road; (b) road barriers or blockades; (c) abandoned vehicles or vehicle parts; (d) pylons or traffic cones; (e) debris on road; (f) rocks or (g) logs.

18. The vehicle as in claim 17 wherein the set of one or more sensors comprise a combination of: (a) one or more LIDAR sensors; (b) one or more radar sensors; and (c) one or more camera sensors; and the set of one or more sensors provide the first set of data to computer vision algorithms that are implemented at least in part with the second trained model to recognize the stationary road obstacles.

19. The vehicle as in claim 18 wherein the first trained model and the second trained model are embodied in a single neural network that includes both of the first trained model and the second trained model.

20. The vehicle as in claim 18 wherein the first trained model is embodied in a first neural network and the second trained model is embodied in a second neural network.
